(19) United States
(12) Patent Application Publication
(10) Pub. No.: US 2026/0091623 A1
(43) Pub. Date: Apr. 2, 2026

(54) POWERING AND ILLUMINATING A TIRE OF A VEHICLE

(71) Applicant: Ford Global Technologies, LLC, Dearborn, MI (US)

(72) Inventors: Keith WESTON, Canton, MI (US); David D. FRISKE, Wolverine Lake, MI (US); Michael Joseph NIKSA, Royal Oak, MI (US); John Robert VAN WIEMEERSCH, Novi, MI (US); Brendan DIAMOND, Naples, FL (US); Stuart C. SALTER, White Lake, MI (US)

(21) Appl. No.: 19/097,992

(22) Filed: Apr. 2, 2025

Related U.S. Application Data
(63) Continuation-in-part of application No. 18/901,726, filed on Sep. 30, 2024.

(51) Int. Cl. B60C 13/00; B60B 21/12; B60R 16/03; H02J 50/10; H02J 50/20

(52) U.S. Cl. CPC B60C 13/001; B60B 21/12; B60R 16/03; H02J 50/10; H02J 50/20

(57) ABSTRACT

The tire may include a tread portion disposed on an outer face of the tire, a bead assembly to operably couple to a rim of a wheel assembly of the vehicle, a sidewall disposed between the tread portion and the bead assembly, and an electroluminescent material disposed at the sidewall to emit light when powered. The vehicle may include a power transfer assembly further including a first power source, and the power transfer assembly may be configured to operably couple the first power source to the electroluminescent material to transfer electrical power to the electroluminescent material. The power transfer assembly may transfer the electrical power to the electroluminescent material responsive to an illumination trigger, and the electrical power may excite the electroluminescent material to emit light.

### CROSS-REFERENCE TO RELATED APPLICATIONS

This application is a continuation-in-part of U.S. patent application Ser. No. 18/901,726, entitled “POWERING AND ILLUMINATING A VEHICLE ACCESSORY,” filed Sep. 30, 2024, the entire contents of which are hereby incorporated herein by reference.

### TECHNICAL FIELD

Example embodiments generally relate to a tire of a vehicle and, more particularly, relate to an illuminated tire.

### BACKGROUND

Tires of vehicles are frequently customized to increase functionality and aesthetic appeal, as well as display desired patterns and designs. In recent years, illumination has been an increasingly popular customization for vehicle accessories. Typical illuminated vehicle accessories utilize light emitting diodes (LEDs) and other wired light emitting elements to provide the necessary illumination.

However, LEDs and other wired light emitting elements may restrict the tire construction and may be difficult to implement in many types of tires without altering the tire design. As such, an illuminated tire that utilizes an electroluminescent material and additive manufacturing production process may be desired.

### BRIEF SUMMARY OF SOME EXAMPLES

In accordance with an example embodiment, a tire of a vehicle may be provided. The tire may include a tread portion disposed on an outer face of the tire, a bead assembly to operably couple to a rim of a wheel assembly of the vehicle, a sidewall disposed between the tread portion and the bead assembly, and an electroluminescent material disposed at the sidewall to emit light when powered. The vehicle may include a power transfer assembly further including a first power source, and the power transfer assembly may be configured to operably couple the first power source to the electroluminescent material to transfer electrical power to the electroluminescent material. The power transfer assembly may transfer the electrical power to the electroluminescent material responsive to an illumination trigger, and the electrical power may excite the electroluminescent material to emit light.

In another example embodiment, a wheel assembly of a vehicle may be provided. The wheel assembly may include a tire to operably couple the vehicle and a driving surface, a rim to operably couple the tire to the vehicle, a power transfer assembly including a first power source to provide electrical power to the wheel assembly, and an electroluminescent material disposed at the tire to emit light when powered. The power transfer assembly may be configured to operably couple the first power source to the electroluminescent material to transfer the electrical power to the electroluminescent material, and the power transfer assembly may transfer the electrical power to the electroluminescent material responsive to an illumination trigger. The electrical power may excite the electroluminescent material to emit light.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a tire for a vehicle in accordance with an example embodiment;

FIG. 2 illustrates a cross-section of a tire in accordance with an example embodiment;

FIG. 3 depicts a cross-section of a tire in accordance with an example embodiment;

FIG. 4 illustrates a block diagram of the power transfer assembly and power charging assembly in accordance with an example embodiment;

FIG. 5 depicts a block diagram of the power transfer assembly and power charging assembly in accordance with an example embodiment;

FIG. 6 illustrates a block diagram of the power transfer assembly and power charging assembly in accordance with an example embodiment;

FIG. 7 depicts a block diagram of the power transfer assembly and power charging assembly in accordance with an example embodiment;

FIG. 8 illustrates a block diagram of the power transfer assembly and power charging assembly in accordance with an example embodiment; and

FIG. 9 depicts a printing assembly for a tire in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about” and “substantially” should be understood to be definite approximations that account for variations in measurements that cannot be, or as one of skill in the art would appreciate, normally are not, measured precisely. Thus, for example, a parameter that is “about” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a tire for a vehicle to increase vehicle functionality. As a result, the tire may provide illumination to augment the vehicle.

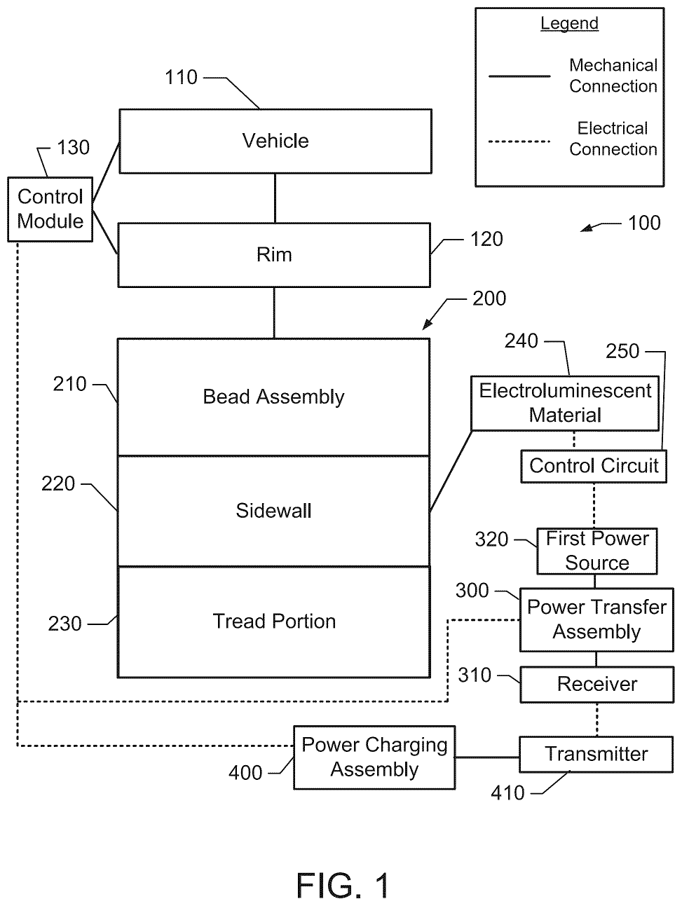

FIG. 1 illustrates a block diagram of a tire 200 for a vehicle 110 in accordance with an example embodiment. In some cases, the vehicle 110 may include a chassis. In an example embodiment, the chassis may be a frame or body of the vehicle 110. The chassis or frame may support and/or may form the foundation structure of the vehicle 110. In some cases, the chassis and/or frame may be formed of one or more casted or welded metal subframes or may be an unibody construction, and a suspension element may be operably coupled to the chassis or frame to help operably couple a wheel assembly 100 to the chassis or frame.

In an example embodiment, as seen in FIG. 1, the tire 200 may be operably coupled to the vehicle 110 via a rim 120. The tire 200 and rim 120 may be included within the wheel assembly 100. The rim 120 may be operably coupled to the chassis or frame of the vehicle via an axle. The tire 200 may include multiple portions that form a unitary body of the tire 200. A bead assembly 210 of the tire 200 may be disposed proximate to the rim 120 and assist with operably coupling the tire 200 and the rim 120. The tire 200 may also include a tread portion 230 disposed on an outer face of the tire 200. The tread portion 230 may include one or more treads to provide increased traction for tire 200 and the vehicle 110. The tread portion 230 may be the portion of the tire 200 on vehicle 110 that is in contact with the driving surface. In some cases, the tread portion 230 may be disposed opposite the bead assembly 210. A sidewall 220 may then connect and operably couple the bead assembly 210 and the tread portion 230. The sidewall 220 may operably couple to both sides of the bead assembly 210 and the tread portion 230, and the sidewall 220 may extend radially outward from a center of the tire 200.

Often, operators and customers desire the tire 200 to include illumination to highlight varying patterns, logos, or other designs of the tire 200. In some cases, the tire 200 may include an electroluminescent material 240 to provide illumination to emit light when powered. The electroluminescent material 240 may be disposed at the sidewall 220 of the tire 200. The electroluminescent material 240 may emit light when excited by the electrical power from a power transfer assembly 300. In some cases, the electroluminescent material 240 may be made of a variety of different methods and materials. For example, the electroluminescent material 240 may be via zinc sulfide compositions with different additional metal types. For instance, depending on the metal type (i.e., copper, silver, manganese, etc.) added with the zinc sulfide compositions, the solution may offer different color and other properties of the electroluminescent material 240.

The electroluminescent material 240 may receive the electrical power from the power transfer assembly 300 directly, or via a control circuit 250. In an example embodiment, the control circuit 250 may be directly operably coupled to the electroluminescent material 240 via forming a wired connection. For example, the wired connection may operably couple to an electroluminescent material electrical connector to provide the electroluminescent material 240 the electrical power. In an example embodiment, the control circuit 250 may operably couple with the power transfer assembly 300 to receive electrical power to transfer to the electroluminescent material 240 via wired or wireless communication (e.g. induction, etc.).

The power transfer assembly 300 may be operably coupled to the vehicle 110 and/or a first power source 320. The first power source 320 may be a number of different types of power sources. In some cases, the first power source 320 is an onboard power source of the vehicle 110 and provides electrical power to the power transfer assembly 300. The onboard power source of the vehicle 110 may include a primary battery of the vehicle 110, a battery for a different system or assembly of the vehicle 110 (i.e., suspension assembly, control systems, etc.), or a battery exclusively to power the electroluminescent material 240 of the tire 200. In an example embodiment, the first power source 320 may be included within the power transfer assembly 300. In some cases, a battery-less approach may occur. For example, the electrical power may be to the tire 200 and electroluminescent material 240 via a solar panel or an external electric vehicle (EV) charger without the intermediary use of a battery.

The power transfer assembly 300 may transfer the electrical power from the first power source 320 to the tire 200 via numerous different methods. For example, the power transfer assembly 300 may transfer the electrical power to the tire 200 via a wired connection or via induction. Inductive power transfer may be a type of wireless power transfer methodology utilized by the power transfer assembly 300. In an example embodiment, the power transfer assembly 300 may include other wireless power transfer methodology. Another wireless power transfer methodology may use a radio frequency (RF) or low frequency (LF) power element. The RF power element may be a wireless power transfer element that picks up low-level radio frequency waves from a source and converts the wave's energy to the electrical power.

A control module 130 may be operably coupled to the tire 200, the power transfer assembly 300, and/or the vehicle 110 in some cases, and the operable coupling may be provided via a variety of methods. The control module 130 may utilize wired or wireless communications to communicate and receive information from vehicle components. In some cases, the control module 130 may receive information from other vehicle control modules connected to the vehicle 110 or external control modules (i.e., databases, service centers, subscription providers, etc.).

In an example embodiment, the control module 130 may be a controller. In some cases, the control module 130 may include one or more control modules (i.e., sub-control modules or operably coupled to other control modules). The control module 130 may include processing circuitry that includes a processor and memory. The processing circuitry may be configured to provide electronic control of the inputs to one or more functional units of the tire 200 or the power transfer assembly 300 and to process data received at or generated by the one or more functional units of the tire 200 or the power transfer assembly 300. Thus, the processing circuitry may be configured to perform data processing, control function execution and/or other processing and management services according to an example embodiment. In some embodiments, the processing circuitry may be embodied as a semiconductor chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules may include similar processing circuitry.

In some cases, a power charging assembly 400 may charge the power transfer assembly 300, and thus the first power source 320. The power charging assembly 400 may be external to the vehicle 110 and have an electrical connection with the power transfer assembly 300. The power charging assembly 400 may include at least one transmitter 410 that may operably couple with at least one receiver 310 of the power transfer assembly 300 to form the electrical connection. The electrical connection between the transmitter 410 and the receiver 310 may be wireless. For example, the power charging assembly 400 may transfer electrical power to the power transfer assembly 300 via methods including but not limited to induction, magnetic resonance charging, and/or electric field charging. In some cases, the control module 130 may also be in communication with the power charging assembly 400 to determine and start a charging process.

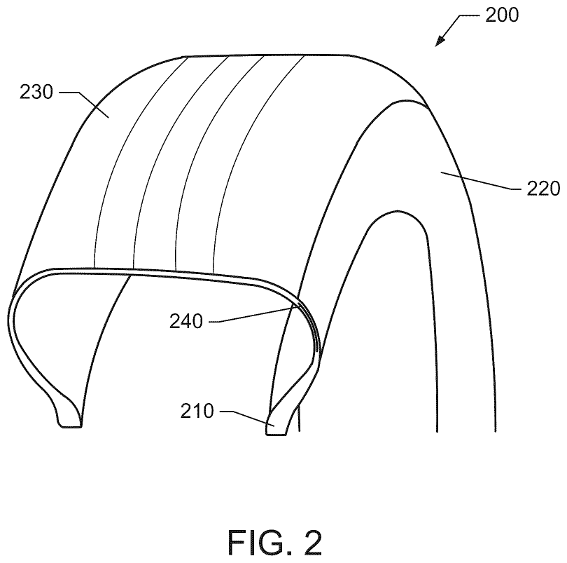

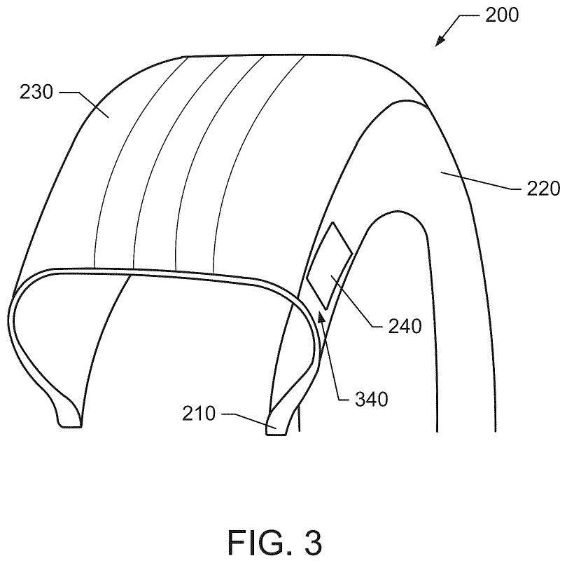

FIGS. 2 and 3 depict a cross-section of the tire according to example embodiments. As seen in FIG. 2, the electroluminescent material 240 may be disposed on or embedded within the sidewall 220. The manufacturing process may embed the electroluminescent material 240 and the control circuit 250 within the tire 200. In some cases, the electroluminescent material 240 may be disposed on an outer surface of the tire 200 (e.g. sidewall) as a patch 340 or other adhesive structure, as seen in FIG. 3. In this regard, the electroluminescent material 240 may be added after complete manufacturing of the tire 200.

In an example embodiment, the power transfer assembly 300 may be disposed with the electroluminescent material 240 and the control circuit 250. For example, the power transfer assembly 300 may be embedded within the tire 200 or incorporated within the patch 340.

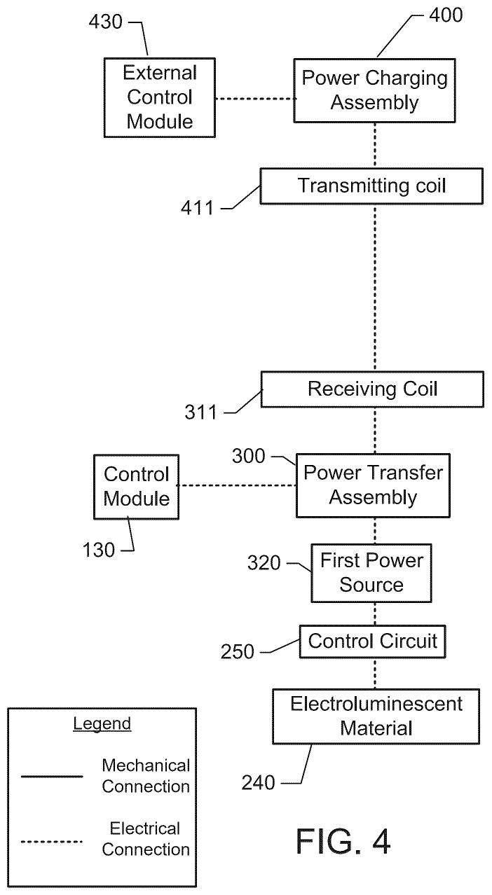

FIG. 4 depicts the power charging assembly 400 and the power transfer assembly 300 utilizing magnetic resonance charging to transfer electrical power. In some cases, the power charging assembly 400 may transfer the electrical power to the power transfer assembly 300 via a resonance-based transfer. In some cases, as seen in FIG. 4, the resonance-based transfer may be magnetic resonance. The power transfer assembly 300 may include a receiving coil 311 as the receiver 310, and the power charging assembly 400 may include a transmitting coil 411 as the transmitter 410. The receiving coil 311 and the transmitting coil 411 may be tuned to resonate at the same magnetic frequency to create a magnetic field. The receiving coil 311 may capture the magnetic energy from the magnetic field and convert the magnetic energy into the electrical power for the power transfer assembly 300, including the first power source 320.

In some cases, the power charging assembly 400 may be disposed at a distance proximate the vehicle 110 and tire 200 between a few centimeters to several meters (10 meters) depending on the strength of the magnetic field created by the transmitting coil 411 when energized. In an example embodiment, the power charging assembly 400 may be disposed at a location where a vehicle 110 is parked, so that the first power source 320 may be charged by the power charging assembly 400 and the power transfer assembly 300 while the vehicle 110 is not being operated.

The power charging assembly 400 may also include an external control module 430. The external control module 430 may determine when to energize the transmitting coil 411 to create the magnetic field. The determination of when to create the magnetic field may include detection of the vehicle 110, receiving a charging trigger from the control module 130, or detecting or receiving an indication that the electrical power stored at the first power source 320 is below a threshold. In this regard, the external control module 430 may include communication mechanisms to communicate with the control module 130 of the vehicle 110 and other systems, as well as sensors (e.g. proximity sensors, magnetic field detection sensors, etc.) to assist in the electrical power transfer. In some cases, the external control module 430 may determine the shared resonant frequency for the transmitting coil 411, and thus the receiving coil 311. The shared resonant frequency may be determined based on a number of factors, including but not limited to interference levels, proximity to the vehicle, and charging status.

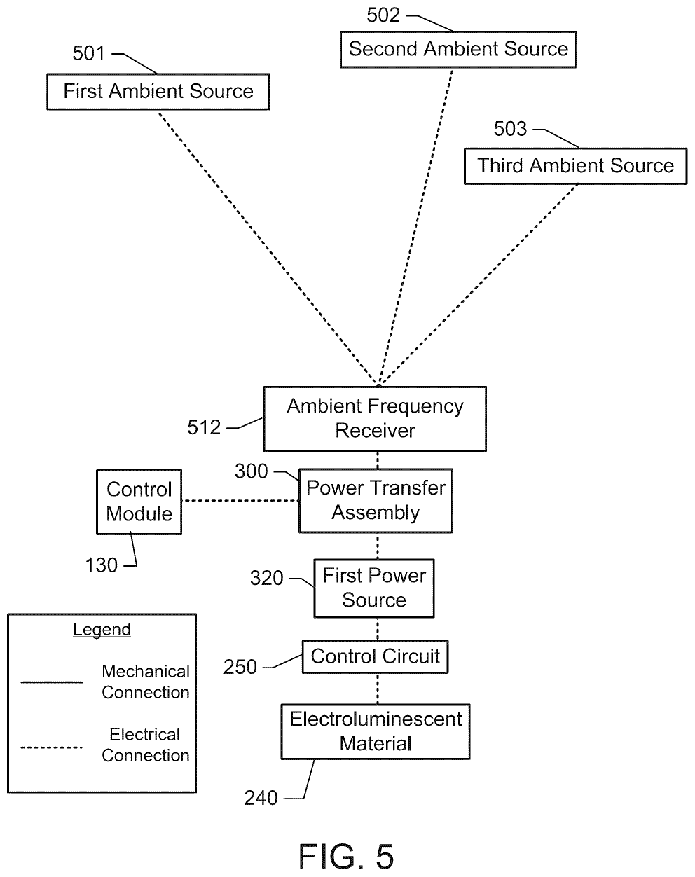

FIG. 5 depicts the power charging assembly 400 and the power transfer assembly 300 utilizing simple electric field to transfer electrical power. In an example embodiment, ambient electromagnetic energy may be received by an ambient frequency receiver 512 and converted by the ambient frequency receiver 512 into the electrical power for use by the power transfer assembly 300. The ambient electromagnetic energy may be radio frequency (RF) or low frequency (LF) electromagnetic energy from sources not associated with or intended for the vehicle 110. In this regard, the ambient electromagnetic energy may include electromagnetic energy from other electronics devices and systems disposed in the environment around the vehicle 110, but not explicitly intended to charge or transfer power to the vehicle 110 or power transfer assembly 300. In some cases, RF electromagnetic energy may be harvested from the vehicle 110 itself, products in the vehicle 110 (e.g. cell phones, hot spots, etc.), and/or adjacent vehicles. In this regard, the RF electromagnetic energy mat still not be intended to be transferred to the power transfer assembly 300, but still may be associated with the vehicle 110. The frequency range for the RF electromagnetic energy may be 3 Hz to 300 GHz, and the frequency range for the LF electromagnetic energy may be a lower range of the RF frequency range (e.g. 30-300 kHz). The ambient electromagnetic energy captured by the ambient frequency receiver 512 may be provided via multiple ambient sources. The multiple ambient sources may each be considered a power charging assembly 400 with a transmitter 410, as each ambient source transmits energy that the power transfer assembly 300 can convert into the electrical power.

In an example embodiment, the multiple ambient sources may include a first ambient source 501, a second ambient source 502, and a third ambient source 503. If the ambient electromagnetic energy is RF electromagnetic energy, the first ambient source 501, the second ambient source 502, and the third ambient source 503 may include but are not limited to radio and TV broadcast stations, cell towers, Wi-Fi routers, and other communication devices. If the ambient electromagnetic energy is LF electromagnetic energy, the first ambient source 501, the second ambient source 502, and the third ambient source 503 may include but are not limited to power lines, household wiring, appliances, and other types of communication equipment. The power transfer assembly 300 and the ambient frequency receiver 512 may harvest or collect the ambient electromagnetic energy while the vehicle 110 is parked or in movement.

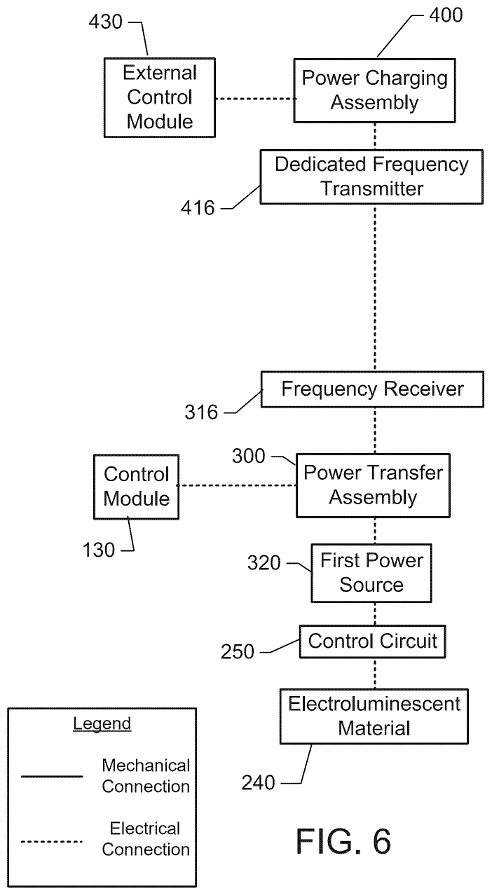

FIG. 6 depicts the power charging assembly 400 and the power transfer assembly 300 utilizing an electric field to transfer electrical power in accordance with an example embodiment. In some cases, a directed beam of electromagnetic energy from a dedicated frequency transmitter 416 of the power charging assembly 400 may be collected by a frequency receiver 316 of the power transfer assembly 300. The dedicated frequency transmitter 416 of the power charging assembly 400 may beamform a beam of electromagnetic energy to be transmitted directly toward the frequency receiver 316. The beamforming may be controlled by the external control module 430, and the beam formed via beamforming may be directed around objects and interference regions between the dedicated frequency transmitter 416 and the frequency receiver 316. For example, the beamforming may direct the beam of electromagnetic energy to bounce off a wall and then towards the frequency receiver 316 to bypass an object disposed between the power charging assembly 400 and the power transfer assembly 300. The beam of electromagnetic energy may have a maximum range of 9 meters or 30 feet. At the maximum range, approximately 20 W of the electrical power may be generated and transferred.

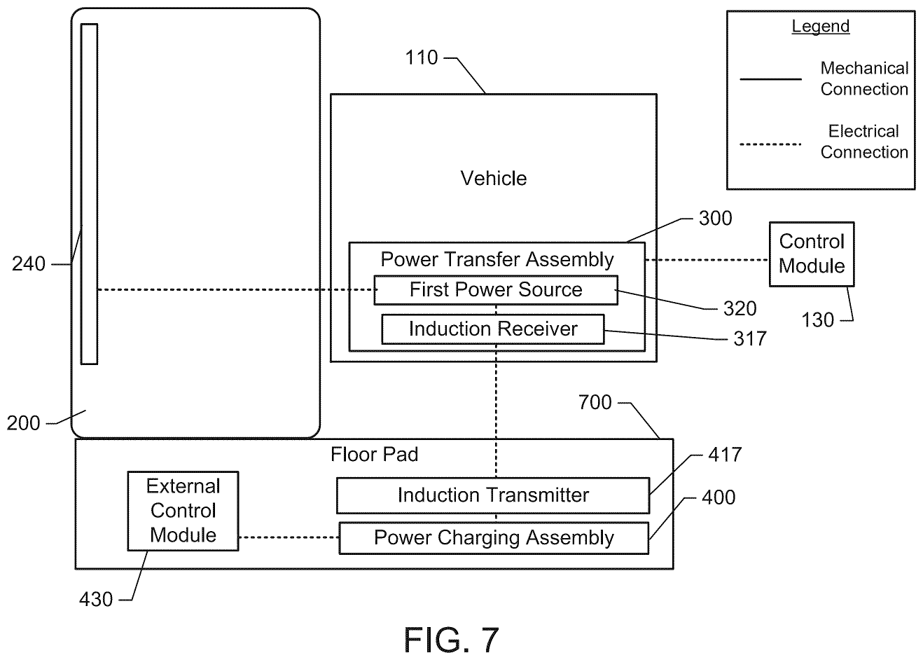

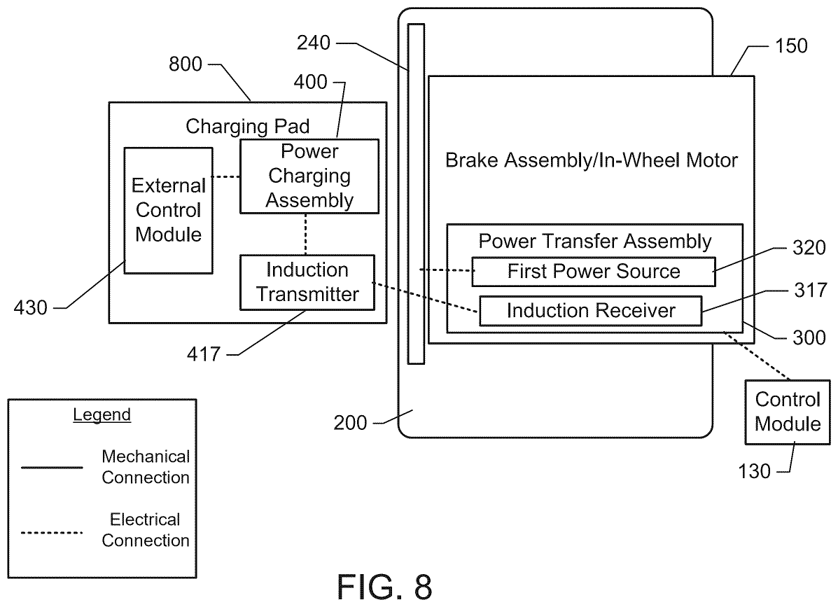

FIGS. 7 and 8 depict the power charging assembly 400 and the power transfer assembly 300 utilizing induction to transfer the electrical power in accordance with an example embodiment. In some cases, the power charging assembly 400 may include an induction transmitter 417 and the power transfer assembly 300 may include an induction receiver 317 to transfer the electrical power via induction. In this regard, the power charging assembly 400 and the power transfer assembly 300 may need to be disposed proximate or within an induction distance to ensure efficient induction energy transfer performance. For example, the induction receiver 317 and the induction transmitter 417 may be disposed within the induction distance of 4 cm of one another for optimal power transfer efficiency (e.g. according to a distance vs. efficiency curve for the induction charger). For example, as seen in FIG. 7, the power transfer assembly 300 may be disposed on an underside of the vehicle 110 that is proximate the power charging assembly 400 integrated within a floor pad 700.

In some cases, the power charging assembly 400 may be disposed on a distinct, charging pad 800 removably operably coupled to the vehicle 110 or the power transfer assembly 300. In this regard, the power charging assembly 400 may be disposed within the induction distance of the power transfer assembly 300 to allow inductive charging without needing to alter the design of the vehicle 110, and the transfer of the electrical power from the power charging assembly 400 to the power transfer assembly 300 may also occur outside of a standard parking location. The charging pad 800 may be magnetic and may secure magnetically to the power transfer assembly 300.

Additionally, the power transfer assembly 300 may be disposed at various locations of the vehicle 110. In an example embodiment, the power transfer assembly 300 may be disposed at a wheel assembly accessory 150, such as the brake assembly of the vehicle 110. For example, the power transfer assembly 300 may be integrated within a carbon fiber weave of the brake assembly. The power transfer assembly 300 may be disposed on the brake caliper housing of the brake assembly. The power transfer assembly 300 may be disposed at other locations within the vehicle 110 as well. In some cases, the power transfer assembly 300 may be embedded within the tire 200 along with the electroluminescent material 240 and the control circuit 250. In an example embodiment, the wheel assembly accessory 150 may include an in-wheel motor, and the power transfer assembly 300 may be disposed on or within the in-wheel motor (e.g. for a hybrid or electric vehicle). Different components of the power transfer assembly 300 may be separated throughout different portions of the vehicle 110. For example, the first power source 320 may be incorporated with the tire 200, valve stem caps, or wheel center caps while the remaining power transfer assembly components are disposed and incorporated with the brake assembly of the vehicle 110.

In some cases, the manufacturing of the tire 200 and the power transfer assembly 300 may be achieved via additive manufacturing and other manufacturing processes. For example, the electroluminescent material 240 may be integrated within a coating and applied to the tire 200. However, in other cases, if the coating is applied, but is not integrated with the electroluminescent material 240, the coating may be translucent so that any light generated by the electroluminescent material 240 may pass through the coating with minimal diminution. The coating may be waterproof and increase the durability and functionality of the tire 200 and the electroluminescent material 240. In an example embodiment, the electroluminescent material 240 may be integrated into other materials (i.e., plastics, fabrics, rubber materials, polymers, etc.) and applied to or integrated within the tire 200. The electroluminescent material 240 may be operably coupled to an electroluminescent material electrical connector to transfer electrical power to the electroluminescent material 240. The electroluminescent material electrical connector may be integrated with the electroluminescent material 240 in the coating or other materials.

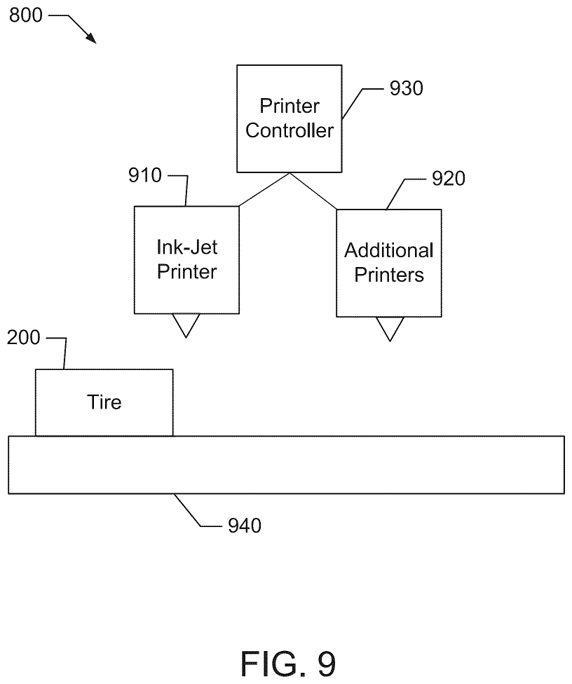

FIG. 9 depicts an additive manufacturing process for the tire in accordance with an example embodiment. The control circuit 250 may be added to the tire 200 via conductive ink printing. In some cases, as shown in FIG. 9, conductive ink printing may be performed via a printing system 900. The printing system 900 may use an ink jet printer 910 to apply very precise circuits to a variety of objects, including fabrics and rigid objects. The conductive ink may be a liquid-based ink. With conductive ink printing, a computer-aided design (CAD) representation of circuitry or electronics may be directly incorporated during or after the primary manufacturing or assembly process of the tire 200 without losing specificity. Conductive ink printing may include conductive inks composed with conductive metal fillers and polymer resins. The conductive metal fillers may provide desired electrical and thermal properties. For example, the conductive metal filler may be silver, as the conductive ink needs to be easily liquefied at relatively low temperatures (i.e., 500° F. or less), while maintaining its conductivity through the printing process and application. In some cases, the temperature threshold may be higher (i.e., 2000° F. or less) depending on the application. The polymer resins may provide mechanical strength and flexibility in application of the conductive ink printing. For example, silver nitrate may be a commonly used ink for conductive ink printing. Forming the control circuit 250 via conductive ink printing may allow for increased flexibility of the tire 200. Additionally, the conductive ink printing may provide increased ease of integration of the control circuit 250. Conductive ink printing may also be conductive ink painting.

The control circuit 250 may be printed and run along the length of the electroluminescent material 240 to provide the necessary electrical power to excite the electroluminescent material 240 to emit light. As such, the electroluminescent material 240 and the control circuit 250 may be disposed along the length of the design or pattern desired to be illuminated on the tire 200. For example, the pattern or design illuminated within the tire 200 includes, but is not limited to, logos, outlines (i.e., perimeter of tire), and Easter eggs (dates, coordinates, etc.). In an example embodiment, the control circuit 250 may transfer electrical power to the electroluminescent material 240 without contacting the electroluminescent material 240. The control circuit 250 may transfer electrical power via creating an electrical field or via electroluminescent material electrical connector.

The illuminable tire 200 may be created via additive manufacturing. For example, the control circuit 250 and the electroluminescent material 240 may be added after the initial formation of the tire 200. In some cases, if the control circuit 250 and the electroluminescent material 240 are embedded within the tire 200, another manufacturing step may be performed to apply the coating or to finish manufacturing the tire 200. The additive manufacturing process may utilize the printing system 900 to manufacture the illuminable tire 200. In some cases, the ink-jet printer 910 and the additional printers 920 may be individual pieces of a larger, single printer. The ink-jet printer 910 and the additional printers 920 may also be operably coupled to and operated via a printer controller 830. In an example embodiment, the ink-jet printer 910 may add the control circuit 250 to the tire 200 prior to the additional printers 920 or other manufacturing methods add the electroluminescent material 240, the coating, and/or the remainder of the tire 200. The additional printers 920 may add additional sensors to the tire 200. For example, a tire pressure monitoring sensor may be added by the additional printers 920. The additional sensors may share the first power source 320 with the electroluminescent material 240 and control circuit 250. In some cases, the moving apparatus 940 may move the tire 200 from the ink-jet printer 910 to the additional printers 920 and vice versa. The moving apparatus 940 may be a conveyer system or other device/system that may move the tire 200 throughout its production process.

In an example embodiment, electrical power may only be transferred to the electroluminescent material 240 responsive to an illumination trigger. The illumination trigger may be a signal transferred by the control module 130 to the power transfer assembly 300 or another control module of the vehicle 110. In some cases, the signal may be transferred automatically based on a vehicle event. For example, a vehicle event may be, but is not limited to, an operation status of the vehicle 110 (powered on, off, reverse, etc.), time of day, vehicle movement, vehicle accessory movement, or an operator input (via phone app, vehicle control interfaces, etc.). Further examples of the vehicle events that may trigger illumination include but are not limited to, are a yaw error being greater than a yaw error threshold, a tire slip event occurring, other vehicles' positions relative the vehicle 110 (e.g. blind spot), locking/unlocking the vehicle 110, and/or fuel status. In some cases, the illumination trigger may be required to be received by the control circuit 250 to excite the control circuit 250 into allowing power to be provided from the first power source 320 to the electroluminescent material 240.

In some cases, the electroluminescent material 240 may be replaced with an alternative light source. The alternative light source may include but is not limited to light emitting diodes (LEDs). The alternative light source may still be powered by the first power source 320 and may receive power via the control circuit 250. In an example embodiment, multiple different electrical power transfer methods may be used by the tire 200. For example, the power transfer assembly 300 may include multiple instances of the receiver 310 to receive the electrical power from multiple instances of the transmitter 410 and the power charging assembly 400. In this regard, the power transfer assembly 300 may collect ambient electromagnetic energy, as well as electrical power received from induction. In some cases, the power transfer assembly 300 may include a piezoelectric electrical power generator to utilize motion of the tire 200 instead of or in addition to external charging from the power charging assembly 400.

A tire of a vehicle may therefore be provided. The tire may include a tread portion disposed on an outer face of the tire, a bead assembly to operably couple to a rim of a wheel assembly of the vehicle, a sidewall disposed between the tread portion and the bead assembly, and an electroluminescent material disposed at the sidewall to emit light when powered. The vehicle may include a power transfer assembly further including a first power source, and the power transfer assembly may be configured to operably couple the first power source to the electroluminescent material to transfer electrical power to the electroluminescent material. The power transfer assembly may transfer the electrical power to the electroluminescent material responsive to an illumination trigger, and the electrical power may excite the electroluminescent material to emit light.

The tire of a vehicle of some embodiments may include additional features, modifications, augmentations and/or the like to achieve further objectives or enhance performance of vehicle systems. The additional features, modifications, augmentations and/or the like may be added in any combination with each other. Below is a list of various additional features, modifications, and augmentations that can each be added individually or in any combination with each other. For example, the first power source may include a battery that receives and stores the electrical power transferred to a receiver of the power transfer assembly from a transmitter of a power charging assembly. In an example embodiment, the power charging assembly may transfer the electrical power to the power transfer assembly via magnetic resonant charging or electric field charging. In some cases, the transmitter may be a transmitting coil and the receiver may be a receiving coil. The transmitting coil and the receiving coil may be tuned to resonate at the same frequency, and responsive to the transmitting coil and the receiving coil resonating at the same frequency, a current induced at the receiving coil may enable a transfer of the electrical energy to the first power source. In an example embodiment, the transmitter may transfer ambient radio frequency electromagnetic energy or low frequency electromagnetic energy from a source not intended for the vehicle, and the receiver may convert the ambient radio frequency electromagnetic energy or low frequency electromagnetic energy to the electrical power to store at the first power source. In some cases, the transmitter may beamform and direct a beam of radio electromagnetic energy towards the receiver, and the receiver may convert the beam of radio frequency electromagnetic energy to the electrical power to store at the first power source. In an example embodiment, the power charging assembly may transfer the electrical power to the power transfer assembly via inductive charging, and the transmitter may be disposed within a pad disposed proximate the tire. In some cases, the receiver may be integrated within a brake assembly or an in-wheel motor of the vehicle disposed proximate the tire. In an example embodiment, the power transfer assembly may be integrated within the tire. In some cases, the illumination trigger may be a signal transferred from a control module of the vehicle, and the signal may be transferred automatically based on a vehicle event. In an example embodiment, the electroluminescent material is integrated within an adhesive patch applied to the sidewall of the tire.

A wheel assembly of a vehicle may be provided. The wheel assembly may include a tire to operably couple the vehicle and a driving surface, a rim to operably couple the tire to the vehicle, a power transfer assembly including a first power source to provide electrical power to the wheel assembly, and an electroluminescent material disposed at the tire to emit light when powered. The power transfer assembly may be configured to operably couple the first power source to the electroluminescent material to transfer the electrical power to the electroluminescent material, and the power transfer assembly may transfer the electrical power to the electroluminescent material responsive to an illumination trigger. The electrical power may excite the electroluminescent material to emit light.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A tire of a vehicle, the tire comprising:
a tread portion disposed on an outer face of the tire;
a bead assembly to operably couple to a rim of a wheel assembly of the vehicle;
a sidewall disposed between the tread portion and the bead assembly; and
an electroluminescent material disposed at the sidewall to emit light when powered,
wherein the vehicle includes a power transfer assembly further comprising a first power source,
wherein the power transfer assembly is configured to operably couple the first power source to the electroluminescent material to transfer electrical power to the electroluminescent material,
wherein the power transfer assembly transfers the electrical power to the electroluminescent material responsive to an illumination trigger, and
wherein the electrical power excites the electroluminescent material to emit light.

2. The tire of claim 1, wherein the first power source includes a battery that receives and stores the electrical power transferred to a receiver of the power transfer assembly from a transmitter of a power charging assembly.

3. The tire of claim 2, wherein the power charging assembly transfers the electrical power to the power transfer assembly via magnetic resonant charging or electric field charging.

4. The tire of claim 3, wherein the transmitter is a transmitting coil and the receiver is a receiving coil,
wherein the transmitting coil and the receiving coil are tuned to resonate at the same frequency, and
wherein responsive to the transmitting coil and the receiving coil resonating at the same frequency, a current induced at the receiving coil enables a transfer of the electrical power to the first power source.

5. The tire of claim 3, wherein the transmitter transfers ambient radio frequency electromagnetic energy or low frequency electromagnetic energy from a source not intended for the vehicle, and
wherein the receiver converts the ambient radio frequency electromagnetic energy or low frequency electromagnetic energy to the electrical power to store at the first power source.

6. The tire of claim 3, wherein the transmitter beamforms and directs a beam of radio electromagnetic energy towards the receiver, and
wherein the receiver converts the beam of radio frequency electromagnetic energy to the electrical power to store at the first power source.

7. The tire of claim 2, wherein the power charging assembly transfers the electrical power to the power transfer assembly via inductive charging, and
wherein the transmitter is disposed within a pad disposed proximate the tire.

8. The tire of claim 1, wherein the receiver is integrated within a brake assembly or an in-wheel motor of the vehicle disposed proximate the tire.

9. The tire of claim 1, wherein the power transfer assembly is integrated within the tire.

10. The tire of claim 1, wherein the electroluminescent material is incorporated within an adhesive patch applicable to the sidewall of the tire.

11. The tire of claim 1, wherein the illumination trigger is a signal transferred from a control module of the vehicle, and
wherein the signal is transferred automatically based on a vehicle event.

12. The tire of claim 1, wherein the electroluminescent material is integrated within an adhesive patch applied to the sidewall of the tire.

13. A wheel assembly of a vehicle, the wheel assembly comprising:
a tire to operably couple the vehicle and a driving surface;
a rim to operably couple the tire to the vehicle;
a power transfer assembly including a first power source to provide electrical power to the wheel assembly; and
an electroluminescent material disposed at the tire to emit light when powered,
wherein the power transfer assembly is configured to operably couple the first power source to the electroluminescent material to transfer the electrical power to the electroluminescent material,
wherein the power transfer assembly transfers the electrical power to the electroluminescent material responsive to an illumination trigger, and
wherein the electrical power excites the electroluminescent material to emit light.

14. The wheel assembly of claim 13, wherein the first power source receives and stores the electrical power transferred to a receiver of the power transfer assembly from at least one transmitter of a power charging assembly.

15. The wheel assembly of claim 14, wherein the power charging assembly transfers the electrical power to the power transfer assembly via magnetic resonant charging or electric field charging.

16. The wheel assembly of claim 15, wherein the transmitter is a transmitting coil and the receiver is a receiving coil,
wherein the transmitting coil and the receiving coil are tuned to resonate at the same frequency, and
wherein responsive to the transmitting coil and the receiving coil resonating at the same frequency, a current induced at the receiving coil enables a transfer of the electrical power to the first power source.

17. The wheel assembly of claim 15, wherein the at least one transmitter transfers ambient radio frequency electromagnetic energy or low frequency electromagnetic energy from sources not associated with the vehicle, and
wherein the receiver converts the ambient radio frequency electromagnetic energy or low frequency electromagnetic energy to the electrical power to store at the first power source.

18. The wheel assembly of claim 15, wherein the at least one transmitter beamforms and directs a beam of radio electromagnetic energy towards the receiver, and
wherein the receiver converts the beam of radio frequency electromagnetic energy to the electrical power to store at the first power source.

19. The wheel assembly of claim 14, wherein the power charging assembly transfers the electrical power to the power transfer assembly via inductive charging, and
wherein the transmitter is disposed within a pad disposed proximate the tire.

20. The wheel assembly of claim 13, wherein the receiver is integrated within a brake assembly or an in-wheel motor of the vehicle disposed proximate the tire.
